(19) United States
(12) Patent Application Publication
(10) Pub. No.: US 2007/0224420 A1
(43) Pub. Date: Sep. 27, 2007

(54) Carpet with directional guide markings

(76) Inventor: Maurice Despins, Edmonton (CA)

Correspondence Address: DINSMORE & SHOHL, LLP, 1900 CHEMED CENTER, 255 EAST FIFTH STREET, CINCINNATI, OH, 45202, US

(21) Appl. No.: 11/717,871

(22) Filed: Mar. 14, 2007

(30) Foreign Application Priority Data
Mar. 14, 2006 (CA) 2539456

(51) Int. Cl. F16J 15/20

(52) U.S. Cl. 428/365

(57) ABSTRACT

A carpet having directional guide markings is provided for orienting the carpet with respect to machine direction. The carpet includes an upper surface and a lower surface visible from the bottom side of the carpet. The fabric carpet backing includes a plurality of linear patterns visible on the lower surface running generally perpendicular to the machine direction from one edge of the carpet to the other. The linear patterns can include a line of text or can include at least first and second linear sub-patterns that are visually distinct from one another. As a result, a directional guide is provided by these linear patterns for orienting the carpet with respect to its machine direction and from left to right even if the carpet is cut along its machine direction.

### TECHNICAL FIELD

The present invention relates to the field of carpets manufactured with markings on its backing. More particularly, the present invention relates to the field of carpets with directional guide markings on its backing to aid in properly orienting pieces of carpet that are being seemed together.

### BACKGROUND

In general, carpet is manufactured by tufting yarn into a primary backing material that is unrolled and fed into the tufting machine. Consequently, a “machine direction” is established for the carpet, namely, the direction in which the carpet was tufted. In addition, other operations such as shearing, coating or printing are performed on the carpet as it passes through a line. For the purposes of this specification, the term “machine direction” is intended to mean the direction in which the carpet is tufted.

It is important for the installer of carpet to be aware of the machine direction of the carpet so that all the adjacent pieces of carpet can be laid down with the same orientation. With some styles, the orientation with respect to machine direction is readily detectable from the face of the carpet. For example, if the carpet uses a particular tufting pattern with different colours of yarn, the resulting carpet face may have a patently directional appearance. Likewise, a carpet may be printed with a pattern that is patently directional.

In contrast, other styles of carpet have directional differences that are not so obvious from the face of the carpet. In particular, the tufting operation itself imparts directionality in the pile, which directionality may not be readily apparent on the face of the carpet. Nevertheless, if two pieces of carpet are laid next to each other with different orientations, the mismatch can be unsightly.

In addition to the directionality of the pile, the particular tufting pattern and colours of yarn used may produce a pattern on the face of the carpet that is similar in both directions, but not identical. Likewise, the directionality of a particular printed pattern may be less than obvious. In addition, various operations performed on the carpet during manufacture, such as tip shearing or coating, may produce subtle directional differences. Such subtle differences may only become apparent after installation, particularly when two pieces of carpet are laid next to each other in a seam.

One solution to this problem has been for the carpet manufacturers to print arrows showing the machine direction on the back of the carpet along one or both of the carpet's edges. Typically, these arrows would be printed on the back of the carpet at or near the end of the carpet manufacturing process. Naturally, printing these arrows requires an additional manufacturing step. The problem with this solution is that the outer edge of the carpet may get cut off so that the installer ends up with a piece without any directional guide. In addition, it is important for some carpet manufacturing processes to maintain the same orientation for post-tufting operations. For example, operations such as printing, shearing or coating should be performed in the same direction in order to insure uniformity between several rolls of the same style of carpet. Printing arrows on the back of the carpet at the end of the carpet manufacturing process does not provide the manufacturer with a directional guide soon enough in this process to aid in the above-mentioned operations.

Another solution to the problem is to print spaced-apart linear patterns that run along the length of a carpet roll. The problem with this solution is that a piece of carpet may be cut lengthwise such that the piece has no linear pattern on its back. This leaves the installer in the situation of not having a directional guide marked on the piece to aid in the proper installation and seeming the piece with another piece of carpet.

It is, therefore, desirable to have a carpet with directional guide markings that will always appear on a carpet when it is cut lengthwise as it comes off of a carpet roll.

### SUMMARY

A carpet having a carpet backing is provided that includes directional guide markings for orienting the carpet with respect to machine direction and left to right orientation. An embodiment of the present invention is a carpet having a primary backing through which fibres are looped or tufted and a secondary backing underneath the primary backing, the secondary backing having a downward-facing lower surface that is visible from the lower side of the carpet. The secondary backing can be a coarsely-woven fabric having warp threads running the length of the carpet, parallel to the machine direction, that are interwoven with weft threads running perpendicular to the warp threads. Alternatively, the secondary backing can be a finely woven fabric or textile sheet material. In another embodiment, the carpet may have an “old-style” construction which includes a single backing layer woven with warp and weft threads through which the carpet fibres are looped or tufted into.

In accordance with an embodiment of the present invention, visible linear patterns are disposed on the downward-facing lower surface of the carpet that run side-to-side across the width of a carpet as it comes off of a carpet roll. The linear patterns can be generally perpendicular to the left and right sides of the carpet although it should be obvious to one skilled in the art that the linear patterns could run diagonally from side to side. In another embodiment, a plurality of the linear patterns is disposed in a spaced-apart fashion on the lower surface of the carpet. All of the linear patterns are oriented in the same general direction. In this manner, the linear patterns on the carpet and their orientation will be visible when the carpet is cut along its length when preparing a piece for seaming to another piece no matter what the width of the cut piece is. This will allow an installer the match the machine direction of the cut piece to the machine direction of another piece of carpet when seaming the pieces together.

In one embodiment of the present invention, the linear patterns are generally parallel to one another. In another embodiment, the linear patterns are generally perpendicular to the sides of the carpet. The linear patterns can be lines of text printed onto or woven into the carpet's backing. The text can be any message or information such as the manufacturer's name, the model name of the carpet, the date of manufacture, the lot number and so on. The actual text printed is not as important as having all of the lines of text printed in the same orientation so as to provide a directional guide to an installer.

In another embodiment, the linear patterns can consist of a first linear sub-pattern and a second linear sub-pattern that are visually distinct from one another. The first sub-pattern can a line of a first colour while the second sub-pattern can be a line of a second colour, the two colours being visually distinct from one another. In another embodiment, the first sub-pattern can be one of a dashed line and a solid line whereas the second sub-pattern is the other. In yet another embodiment, the first sub-pattern can be a first dashed line and the second sub-pattern can be a second dashed line visually distinguishable from the first dashed line. In another embodiment, the first and second sub-patterns are solid lines of visually different widths.

In instances where the carpet of the present invention comprises a woven backing with warp and weft threads, the first and second sub-patterns can be first and second weft threads, each of a different colour. Alternatively, the second sub-pattern can include a third weft thread of the same colour as the second weft thread or of a third colour, the second weft thread disposed between the first and third weft threads. In another embodiment, the first, second and third weft threads are all of the same colour with the distance between the first and second weft threads visually different from the distance between the second and third weft threads.

Broadly stated, one aspect of the present invention involves a carpet, comprising an upward-facing upper surface having a plurality of carpet fibres or loops extending upwards therefrom, and a downward-facing lower surface; an edge running substantially along the length of said carpet on a left side and on a right side of said carpet; and a plurality of spaced-apart linear patterns visible on said lower surface, said patterns running across at least a portion of the width of said carpet between said left and right sides, said linear patterns all oriented in substantially the same direction thereby providing a guide for orienting said carpet when said carpet is cut along its length.

The present invention, together with attendant objects and advantages, will be best understood with reference to the detailed description below in connection with the attached drawings.

### BRIEF DESCRIPTION OF THE DRAWINGS

FIG. 1 is a side cross-sectional view of a carpet made in accordance with an embodiment of the present invention.

FIG. 2 is a side cross-section view of an alternate form of carpet made in accordance with an embodiment of the present invention.

FIG. 3 is a perspective view of the lower surface of a carpet made in accordance with an embodiment of the present invention.

FIG. 4 is a bottom plan view of a carpet made in accordance with an alternate embodiment of the present invention.

FIG. 5 is a bottom plan view of a carpet made in accordance with another alternate embodiment of the present invention.

FIG. 6 is a bottom plan view of a carpet made in accordance with another alternate embodiment of the present invention.

FIG. 7 is a bottom plan view of a carpet made in accordance with another alternate embodiment of the present invention.

FIG. 8 is a bottom plan view of a carpet made in accordance with another alternate embodiment of the present invention.

### DETAILED DESCRIPTION

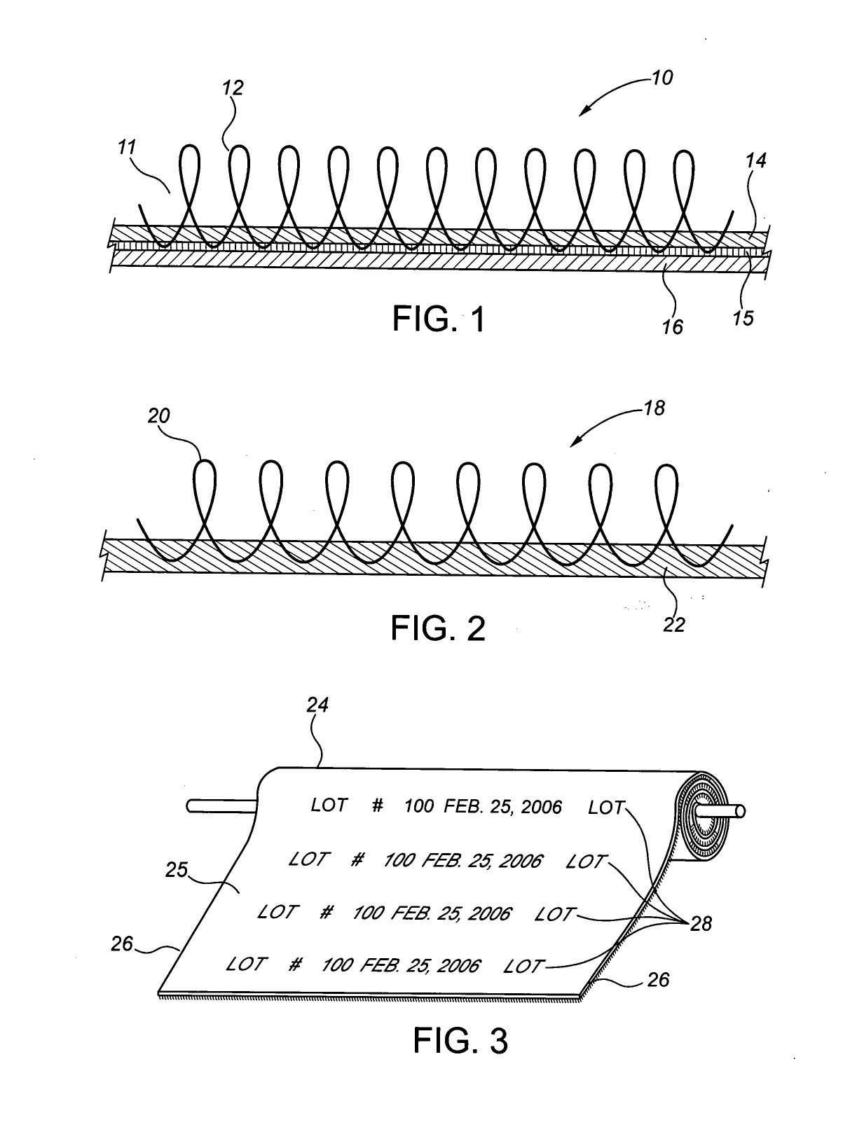

Referring to the figures, FIG. 1 is a side cross-sectional view of a typical construction of a carpet 10. Carpet 10 includes an upper surface 11 made of fibre loops 12 that have been tufted into a primary backing 14. Although FIG. 1 shows fibre loops 12, it should be obvious to those skilled in the art that other tufted face constructions such as cut pile, textured cut pile and tip-sheared in addition to non-tufted face construction such as needle punch, woven and fusion-bonded are all within the scope of the present invention.

Similarly, the selection of the material for the primary backing 14 can be made from a variety of materials. An example of such a material is a woven polypropylene fabric as sold by Amoco under the designation POLY BAC®.

As shown in FIG. 1, a polymeric coating 15 is typically applied to the lower side of primary backing 14 after loops 12 have been tufted into primary backing 14 to lock loops 12 into place. An example of such a coating is styrene butadiene rubber latex material filled with CaCO₃. A typical application of coating 15 is approximately 28 oz./sq. yard. Secondary backing 16 is applied to primary backing 15 and can be adhered by a coating 15.

Secondary backing 16 is a fabric material that can be selected from a wide variety of materials such as polypropylene, fibreglass, polyester, jute and combinations thereof. Secondary backing 16 can be a finely woven sheet textile material or it can be a coarsely woven material such that the warp and weft threads are clearly visible. For the purposes of this specification, the warped threads run lengthwise with the carpet as it comes off a roll and are parallel to the machine direction of the carpet whereas the weft threads run crosswise along the width from edge to edge of the carpet and are perpendicular and interwoven with the warp threads. An example of a material suitable for secondary backing 16 is a woven polypropylene material sold by Amoco under the designation ACTION BAC®. This particular material has warped threads of slit film polypropylene and weft threads of polypropylene spun yarn.

In FIG. 2, an alternate form of a carpet in accordance with an embodiment of the present invention as shown. In this case, carpet 18 comprises fibre loops 20 woven directly into a single backing 22 having warped threads interwoven with weft threads. This is an “older” or traditional form of carpet construction and does not have any further secondary backings underneath backing 22.

Referring to FIG. 3, an embodiment of the present invention is shown. Lines of text 28 are printed on lower surface 25 of carpet roll 24. Lines of text 28 provide a visual linear pattern when printed in the same orientation and in a repeated, spaced apart fashion along the length of carpet roll 24. The space between the visual linear patterns can be any practical distance as determined by a person skilled in the art. Typically, the spacing between the visual patterns can be in the range of one foot to eight feet.

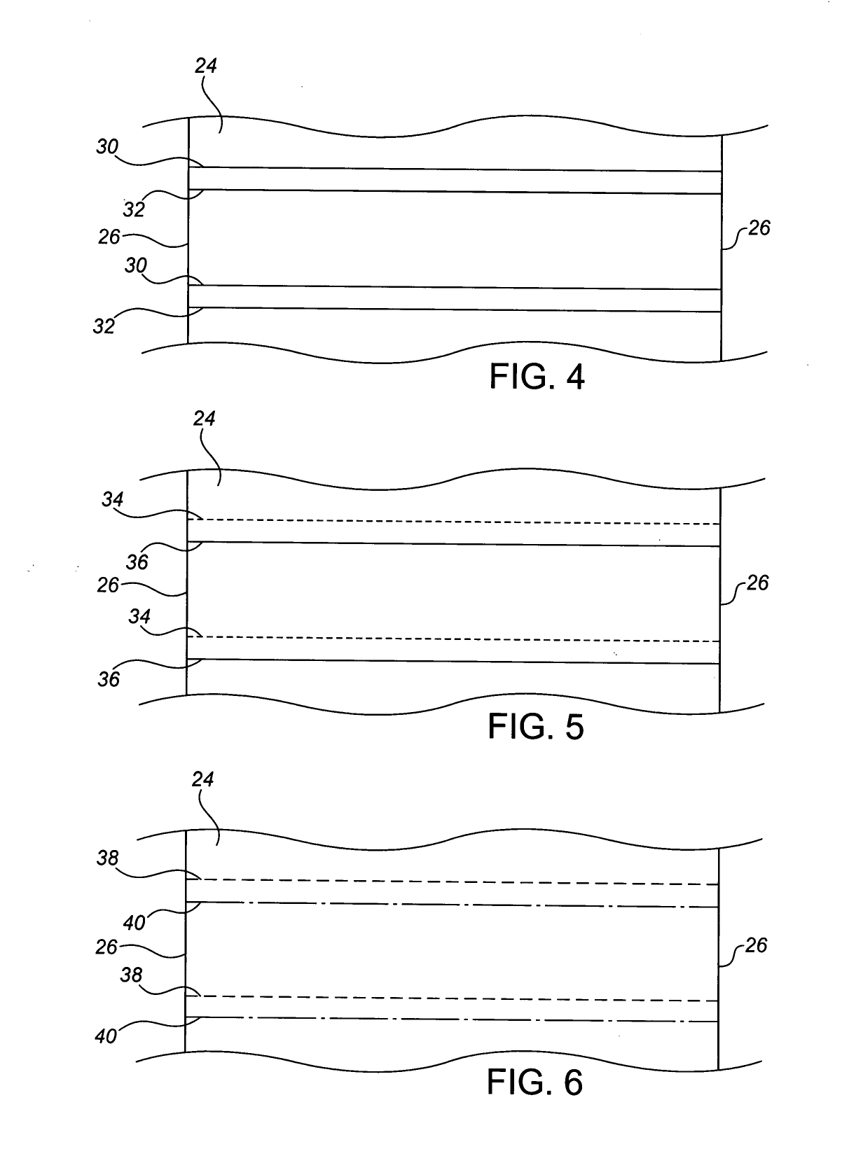

Referring to FIG. 4, the visual linear patterns include a pair of visual linear sub-patterns that run from edge 26 to edge 26 of carpet 24. In this example, the first linear sub-pattern are lines 30 of a first colour whereas the second linear sub-pattern are lines 32 of a second colour that is visually distinguishable from the first colour. In other embodiments, lines 30 and 32 can be the same colour but of different widths so as to visually distinguish one line from the other.

Referring to FIG. 5, another embodiment of the present invention is shown. In this case, the first linear sub-pattern are dashed lines 34 whereas the second linear sub-pattern are solid lines 36.

Referring to FIG. 6, another embodiment of the present invention is shown. In this case, the first linear sub-pattern are first dashed lines 38 whereas the second linear sub-pattern are second dashed lines 40 that are visually distinct from first dashed lines 38.

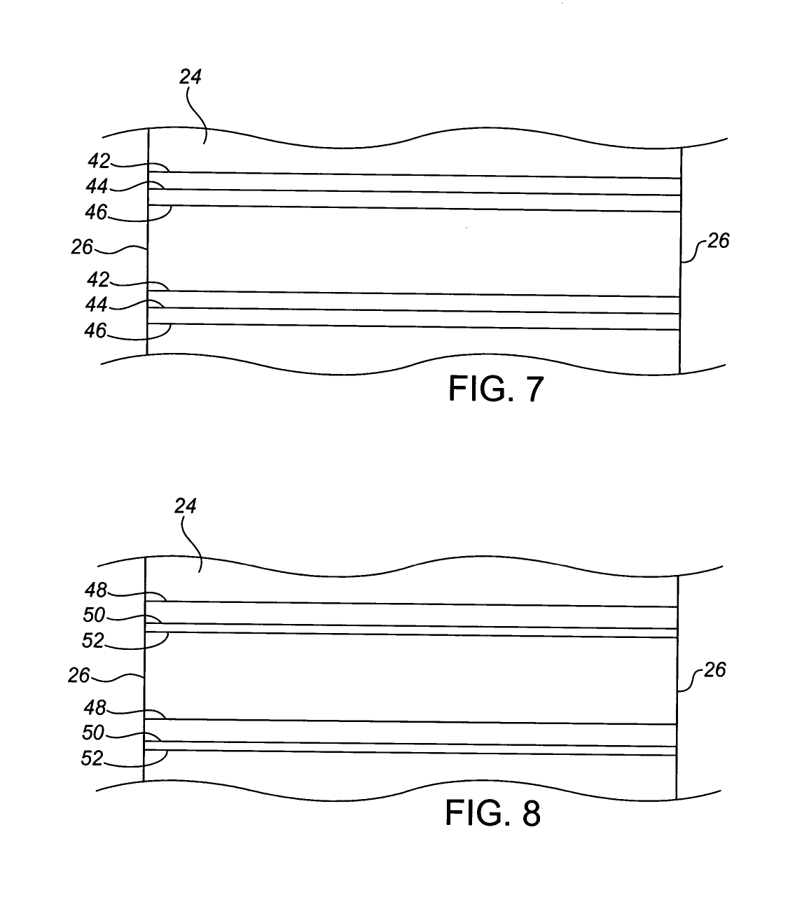

Referring to FIG. 7, another embodiment of the present invention is shown. In this case, there are three lines that make up the visual linear pattern. A first linear sub-pattern includes solid line 42 having a first colour whereas the second linear sub-pattern includes solid lines 44 and 46 that are both of a second colour that is visually distinct from the first colour of line 42. In this manner, an asymmetrical colour pattern is provided as a directional guide as so the machine direction of the carpet. Alternatively, lines 42, 44 and 46 can all be of different colours that are visually distinct from one another.

Referring to FIG. 8, yet another embodiment of the present invention is shown. In this case, there are three lines in an asymmetrical configuration. A first linear sub-pattern are lines 48 whereas a second linear sub-pattern consists of lines 50 and 52. Furthermore, in this example, the distance between lines 48 and 50 is greater than the distance between lines 50 and 52 although it should be obvious to a person skilled in the art that the distance between lines 48 and 50 can be less than the distance between lines 50 and 52.

In viewing the invention as shown in FIGS. 2 to 8, it should be obvious that the visual linear patterns can be printed on secondary backing 16 whether backing 16 is a finely woven textile fabric or a coarsely woven fabric having warp and weft threads. It should also be obvious that the visual patterns need not be printed such that they are substantially perpendicular to the machine direction of the carpet as shown. Rather, the visual patterns can be printed diagonally across the width of the carpet from edge to edge.

In respect of the embodiments of the present invention shown in FIGS. 4, 7 and 8 where secondary backing 16 is a coarsely woven fabric having warp and weft threads, it should be obvious to a person skilled in the art that the linear sub-patterns can be made up of weft threads having different colours woven into secondary backing 16.

As noted above, one method of applying linear patterns to the carpet and backing is to weave different coloured yarns into the backing material. This provides the advantage that the directional guide is provided integrally with the carpet backing. That is, the carpet manufacturer can obtain the carpet backing with the directional guide already present. As a result, the carpet manufacturer does not need to add any steps to its process, such as printing a directional guide on the carpet backing. Also, the directional guide is available to the carpet manufacturer as soon as the backing is applied to the carpet. Thus, the carpet manufacturer can use the directional guide to insure that rolls of carpet are oriented the same as they go through operations such as printing, shearing or coating.

It should also be noted that, although much of the discussion has involved woven carpet backings, other types of backing fabrics could also be used. For example, non-woven fabrics such as spun-bond polyester can also be used. In addition, polyester fleece can also be used. Although much of the discussion has involved the method of weaving coloured yams into a woven fabric backing, the linear patterns may be applied by other means such as printing or dyeing. For the purposes of this specification, “printing” linear patterns onto carpet backings shall include the “dyeing” of those patterns as well. Certainly, these and all other modifications that are within the ordinary skill in the art to make are considered to lie within the scope of the invention as defined by the appended claims.

Although embodiments of the present invention have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

What is claimed is:

1. A carpet, comprising:
a) an upward-facing upper surface having a plurality of carpet fibres or loops extending upwards therefrom, and a downward-facing lower surface;
b) an edge running substantially along the length of said carpet on a left side and on a right side of said carpet; and
c) a plurality of spaced-apart linear patterns visible on said lower surface, said patterns running across at least a portion of the width of said carpet between said left and right sides, said linear patterns all oriented in substantially the same direction thereby providing a guide for orienting said carpet when said carpet is cut along its length.

2. The carpet as set forth in claim 1 wherein said spaced-apart linear patterns are substantially parallel to one another.

3. The carpet as set forth in claim 1 wherein said spaced-apart linear patterns are substantially perpendicular to said edges.

4. The carpet as set forth in claim 1 further comprising a secondary backing wherein said lower surface is disposed on said secondary backing.

5. The carpet as set forth in claim 4 wherein said secondary backing is a coarsely woven fabric comprising warp and weft threads.

6. The carpet as set forth in claim 4 wherein said secondary backing is a finely woven fabric or a non-woven fabric.

7. The carpet as set forth in claim 1 wherein said linear patterns are lines of text printed on said lower surface.

8. The carpet as set forth in claim 1 wherein each of said linear patterns comprises at least a first and second linear sub-pattern running at least a portion of the length of said linear patterns, said first and second sub-patterns visually distinct from one another.

9. The carpet as set forth in claim 8 wherein said first linear sub-pattern is a line of a first colour is said second linear sub-pattern is a line of a second colour, said first and second colours visually distinct from one another.

10. The carpet as set forth in claim 8 wherein said first linear sub-pattern is one of a dashed line and a solid line and said second linear sub-pattern is the other said dashed line and said solid line.

11. The carpet as set forth in claim 8 wherein said first linear sub-pattern is a first dashed line and said second linear sub-pattern is a second dashed line, said first and second dashed lines visually distinct from one another.

12. The carpet as set forth in claim 8 wherein said first linear sub-pattern is a first solid line and said second linear sub-pattern is a second solid line, said first and second solid lines having widths visually distinct from one another.

13. The carpet as set forth in claim 5 wherein said first linear sub-pattern comprises a first weft thread of a first colour and said second linear sub-pattern comprises a second weft thread of a second colour, said first and second colours visually distinct from one another.

14. The carpet as set forth in claim 13 wherein said second linear sub-pattern further comprises a third weft thread of said second colour, said second weft thread positioned between said first and third weft threads.

15. The carpet as set forth in claim 5 wherein said first linear sub-pattern comprises a first weft thread of a first colour and said second linear sub-pattern comprises second and third weft threads of said first colour, the distance between said first and second weft threads visually distinct from the distance between said second and third weft threads.

16. The carpet as set forth in claim 1 wherein said linear patterns are spaced between about one foot and about eight feet apart along the length of said lower surface.
